(19) United States
(12) Patent Application Publication
(10) Pub. No.: US 2008/0049384 A1
(43) Pub. Date: Feb. 28, 2008

(54) Cooling device for an electrical operating means

(75) Inventors: Peter Unternaehrer, Wurenlos (CH); Martin Lakner, Gebenstorf (CH); Jean-Claude Mauroux, Hunzenschwil (CH); Daniel Chartouni, Baden (CH); Tilo Buhler, Wettingen (CH); David Just, Ennetbaden (CH)

Correspondence Address: BUCHANAN, INGERSOLL & ROONEY PC, POST OFFICE BOX 1404, ALEXANDRIA, VA, 22313-1404, US

(73) Assignee: ABB Research Ltd, Zurich (CH)

(21) Appl. No.: 11/889,942

(22) Filed: Aug. 17, 2007

(30) Foreign Application Priority Data
Aug. 25, 2006 (EP) 06405368.9

(51) Int. Cl. H02B 1/56; B21D 53/02; F28D 7/00

(52) U.S. Cl. 361/677; 165/104.21; 29/890.032

(57) ABSTRACT

A cooling device is disclosed for an electrical operating means, which has a surface to be cooled. The cooling device comprises a coolant, a peripheral wall, whose interior defines a volume for the coolant, a fastening for fastening the cooling device to the electrical operating means, and a contact-pressure means. The peripheral wall has a thermally conductive contact wall with a contact face, which is designed for areal contact with the surface to be cooled. The contact-pressure means mechanically prestresses the contact wall in order to produce an areal contact pressure of the contact face against the surface to be cooled when the cooling device is fastened to the electrical operating means.

### RELATED APPLICATIONS

This application claims priority under 35 U.S.C. §119 to EP Application 06405368.9 filed in Europe on Aug. 25, 2006, the entire contents of which are hereby incorporated by reference in their entireties.

### TECHNICAL FIELD

The invention relates to a cooling device, in particular a cooling device for an electrical operating means and to an electrical operating means having a cooling device fastened thereto, as well as to a method for producing a cooling device, in particular a cooling device for an electrical operating means.

### BACKGROUND INFORMATION

Outgoing generator lines with forced cooling are known from K. Albert et al., Elektrischer Eigenbedarf/Energietechnik in Kraftwerken und Industrie [Electrical auxiliaries service/energy technology in power stations and industry], VDE-Verlag, ISBN 3-8007-1586-4, Chapter 10.3 (pages 431-455). In order to cool the inner conductor of the outgoing generator line, an air flow is produced by means of blowers. Furthermore, it is known from EP 1 022 830 A1 to provide a blower for the purpose of cooling an enclosed inner conductor of a heavy-duty circuit breaker.

With these and other cooling systems, the connection between the cooling system and the part to be cooled has room for improvement for continuous operation. For example, the connection does not always have optimum heat conduction properties and therefore limits the cooling effect which can be achieved. Also, the heat conduction properties are not always stable during long-term operation. Therefore, reliable continuous operation can only be ensured with regular complex diagnosis and possible maintenance of this connection.

### SUMMARY

The present invention attempts to alleviate at least some of the abovementioned problems. Exemplary advantages, features, aspects and details of the invention as well as exemplary embodiments and particular aspects of the invention are given in the description and the figures.

In accordance with one aspect of the invention, a cooling device for an electrical operating means which has a surface to be cooled is proposed. The cooling device comprises a coolant. The cooling device furthermore comprises a peripheral wall, whose interior defines a volume for the coolant, as well as a fastening for fastening the cooling device to the electrical operating means. The peripheral wall has a thermally conductive contact wall with a contact face. The contact face is designed for areal contact with the surface to be cooled, i.e. it permits areal contact between the contact face and the surface to be cooled. The areal contact does not require all of the regions of the contact face to be in touching contact with the surface to be cooled. Instead, areal contact is defined, for example, independently of small micro-irregularities. For areal contact, it is furthermore not absolutely necessary for the contact face to be in touching contact with the surface to be cooled at all; instead such contact is also present, for example, when there is a thermally conductive paste or another material between the faces. It is therefore sufficient for areal contact if at least one areal region of the contact face is substantially matched in terms of shape to the surface to be cooled. Furthermore, the cooling device comprises a contact-pressure means. The contact-pressure means prestresses the contact wall in order to produce an areal contact pressure, i.e. a contact pressure which is distributed over an area, of the contact face against the surface to be cooled when the cooling device is fastened to the electrical operating means.

Owing to the contact pressure, a force-fitting connection can be achieved between at least part of the contact face and the surface to be cooled. Owing to the force-fitting connection, good thermal contact which is stable over long time periods can be achieved between the contact face and the surface to be cooled even in the presence of manufacturing tolerances or of other surface irregularities. The contact-pressure means makes it possible to design the contact wall to be thin and therefore particularly thermally conductive and nevertheless for it to bear against the surface to be cooled.

In accordance with one further aspect of the invention, an electrical operating means having a cooling device is proposed. The cooling device is fastened to the electrical operating means by means of a fastening and has the features described in the preceding sections.

The contact-pressure means can serve the purpose of producing a force-fitting connection between the contact wall and the surface to be cooled. For this purpose, in embodiments, the contact wall has a flexible or even a resilient region having a variable and typically pressure-dependent or force-dependent deflection. The resilient region of the contact wall may have a deflection of more than 0.001 mm per 1 N of normal force or of more than 1 mm per 1 bar of pressure onto the region. In general, the pressure-dependent or force-dependent deflection is directed normal to the surface. The contact-pressure means then acts on the flexible region of the contact wall and in particular can press the movable region against the surface to be cooled.

In embodiments, the contact-pressure means is a spring. This may be a helical spring, a leaf spring, a plate spring or another spring. The spring may be formed integrally with the peripheral wall or be separate. The spring may or may not be fastened to the peripheral wall. Preferably, the contact-pressure means is arranged in the volume for the coolant or in the interior of the peripheral wall or directly adjoins the volume or the interior. Particularly preferably, the contact-pressure means is arranged completely in the volume for the coolant or in the interior of the peripheral wall. The contact-pressure means preferably contains metal and particularly preferably steel.

In embodiments, the contact-pressure means is arranged in order to transfer a counterpressure to the contact pressure onto the peripheral wall. As a result, a compact and stable construction is possible. In particular embodiments, the counterpressure to the contact pressure is transferred onto one wall of the peripheral wall which is opposite the contact wall.

In embodiments, the electrical operating means is a switch, a transformer or a surge arrester. For example, the electrical operating means is a circuit breaker, in particular a heavy-duty circuit breaker, for example of a high-voltage installation. The electrical operating means may be a generator circuit breaker.

In embodiments, the coolant is liquid and/or gaseous. In embodiments, a phase transition between a liquid phase and a gaseous phase of the coolant is provided for achieving the cooling effect. The coolant is then, for example, evaporated by thermal energy from the surface to be cooled being absorbed and condensed with heat being emitted to the surrounding environment.

In embodiments, the cooling device is a passive cooling device, for example a heat pipe or a heat siphon. In some of these embodiments, the peripheral wall forms an evaporator for evaporating the coolant, and the cooling device further comprises a condenser for condensing the coolant, which condenser is connected to the evaporator and has an apparatus for emitting heat to the surrounding environment, for example a cooling rib arrangement. These embodiments have the advantage that an efficient cooling effect can be brought about without any or with little energy consumption.

In embodiments, the cooling device comprises a plurality of evaporators, each having at least one contact face, which contact faces are fluid-connected to one another.

In embodiments, the coolant is contained in the volume defined by the interior of the peripheral wall. In embodiments, the interior of the peripheral wall is sealed off in a gas-tight manner from the surrounding environment or from the ambient air. It is therefore possible to prevent the coolant from entering the surrounding environment and therefore to prevent the cooling effect from being reduced. A possibly environmentally harmful effect of the coolant is also reduced.

In embodiments, the cooling device is fastened to the electrical operating means. Optionally, a thermally conductive paste is provided between the contact face and the surface to be cooled.

In embodiments, the contact wall has a base material and a coating. The base material may contain, for example, copper, aluminum or steel. The coating is generally arranged on the side of the contact face. The coating is generally softer than the base material, i.e. it has a lower Brinell hardness than the base material. The coating may contain silver. The coating has the advantage that it can compensate for small irregularities of the contact face or of the surface to be cooled and that, nevertheless, a stable construction of the contact wall consisting of a suitable material is possible.

In general, the prestress has a component in a direction which is normal to the contact face and is directed towards the exterior of the peripheral wall.

In embodiments, the cooling device is formed such that it extends as far as outside the electrical operating means when the cooling device is fastened to the electrical operating means.

In embodiments, the pressure of the coolant or the pressure in the interior of the peripheral wall in the given operating conditions is not below a minimum pressure, and the contact pressure is greater, and optionally greater by more than 0.2 bar or even by more than 0.5 bar, than the difference between the pressure of the surrounding environment, for example the ambient air, and the minimum pressure. In embodiments, the contact pressure of the contact-pressure means is more than 0.5 bar, typically more than 1 bar or even more than 2 bar.

In embodiments, the contact wall is thinner than 1 mm. In embodiments, the contact-pressure means produces the contact pressure in a region of the contact face which is thinner than 1 mm. In embodiments, the contact wall has a thermal conductivity which is less than 80 W/(m×K). In embodiments, the area of the contact face is more than 10 cm².

### BRIEF DESCRIPTION OF THE DRAWINGS

The invention will be explained in the text which follows using general properties and using individual exemplary embodiments illustrated in the figures, in which:

FIG. 1 shows a schematic view for illustrating the way in which a cooling device functions;

FIGS. 2a and 2b each show a cross-sectional view of an electrical operating means with a cooling device fastened thereto;

FIG. 3a shows a schematic view of a cooling device which is not in accordance with the invention without contact-pressure means;

FIG. 3b shows a schematic view of a cooling device according to the invention with contact-pressure means;

FIG. 4 shows a measurement graph, which makes it possible to compare the cooling effect of the cooling devices from FIG. 3a and FIG. 3b; and

FIGS. 5 to 7 show schematic views of further cooling devices according to the invention.

### DETAILED DESCRIPTION

FIG. 1 shows a schematic view of a heat siphon 3 for cooling a heat source 10, for example an electrical operating means. The heat source 10 has a surface 12 to be cooled, through which heat is emitted from the heat source 10 to the heat siphon 3. The heat siphon 3 comprises a peripheral wall 30, whose internal volume 22 contains a coolant 26. The internal volume 22 is generally sealed off in a gas-tight manner from the surrounding environment. In order that the coolant 26 does not escape even during long-term operation, the sealing of the volume 22 meets the requirements for a high vacuum.

The lower region of the heat siphon 3 is in the form of an evaporator 20. The evaporator 20 is in thermal contact with the heat source 10. For this purpose, part of the peripheral wall 30 is in the form of a contact wall 32 with a contact face. The contact face is in areal contact with the surface 12 to be cooled of the heat source 10. An upper region of the heat siphon 3 is in thermal contact with a heat sink 50 (condenser). Any known heat sink may be used. The heat sink 50 can be formed, for example, by cooling ribs or the like, which are preferably located in a natural or artificial air flow. In particular, an air flow can be produced as convection current by heating of the heat sink 50. The heat sink 50 may be formed integrally with the peripheral wall 30 or with part of the peripheral wall. As an alternative to the cooling rib arrangement, other apparatuses for emitting heat, for example heat exchangers, can also be used. Forced cooling is in this case also conceivable, for example by means of fans.

The coolant 26 located in the internal volume 22 is at least partially liquid. It is advantageous for effective heat dissipation from the contact wall 32 if the coolant is liquid in the region of the contact wall 32 and at least wets it. Owing to heat from the heat source 10 being absorbed via the contact wall 32, some of the coolant 26 is evaporated. The coolant vapor rises in the vicinity of the heat sink (condenser) 50 and carries thermal energy with it in the process. Whilst emitting heat to the heat sink 50, the coolant 26 condenses. The condensed, i.e. liquefied coolant 27 passes back to the evaporator. A similar heat siphon is described in patent application EP 04405704.0, which is incorporated in the present application by reference.

The heat flow relevant for the cooling effect is summarized in FIG. 1 by thick black arrows. The heat flow is as follows: the heat is transferred from the surface 12 of the heat source 10 onto the contact wall 32 of the heat siphon 3, and is passed from there into an upper region of the heat siphon and then passed to the heat sink 50.

In the described thermosiphon, the return transport of the condensed coolant primarily takes place by means of gravitation, since there is a monotonic drop between the condenser and the evaporator. More generally, a heat pipe may be used, in which case other means for passing the cooling gas back from the condenser to the evaporator are also provided, for example by means of capillary forces.

Advantageously, the heat pipe is sealed in a gas-tight manner (hermetically), with the result that a closed circuit can be produced therein. An elongated or tubular form of the heat pipe is advantageous, but not essential. The described heat pipe is a passive cooling apparatus. It does not require any power supply or other type of supply. As a cooling system with a hermetically sealed circuit, it generally does not require any maintenance and can function without any maintenance generally over years and decades.

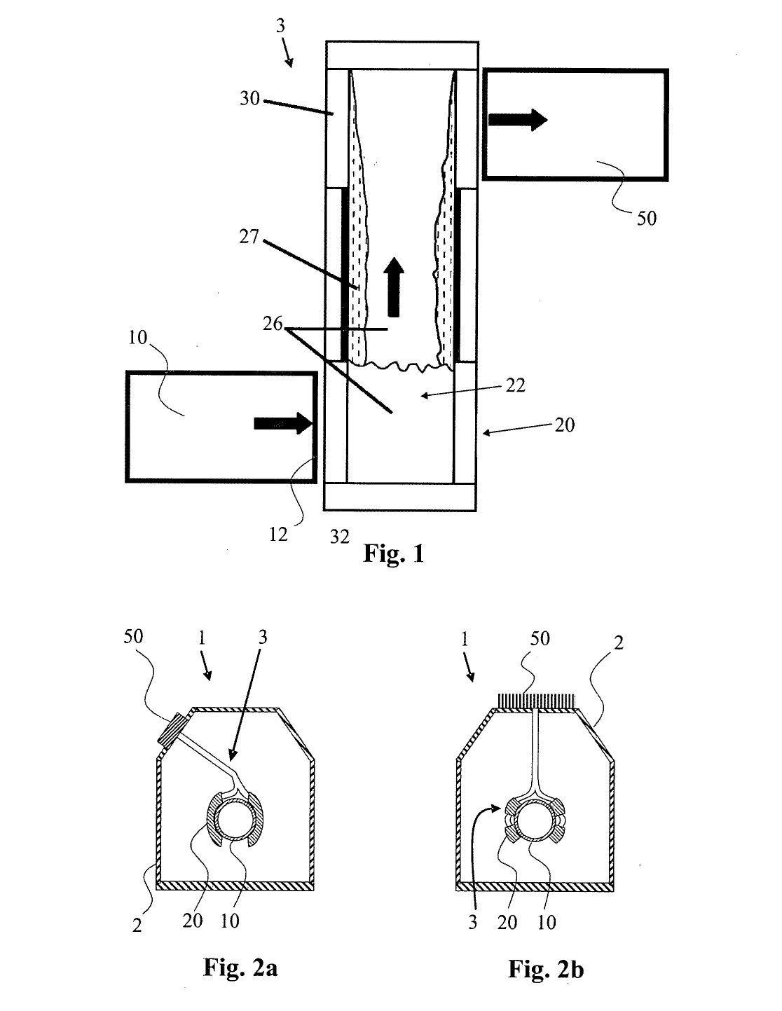

FIGS. 2a and 2b each show a cross-sectional view of an electrical operating means 1 with a cooling device 3 fastened thereto. The electrical operating means 3 illustrated in FIGS. 2a and 2b is a generator circuit breaker for in each case one breaker pole of a generator. Each of the breaker poles has a tubular inner conductor 10, which is surrounded by in each case one enclosing breaker outer conductor 2. During operation, a high voltage is applied between the inner conductor 10 and the respective outer conductor 2, the outer conductor 2 being at ground potential G. The outer conductor may also be referred to as an enclosure for the electrical operating means.

Heat losses occur at the inner conductor 10 and at the outer conductor 2 during operation. The heat is substantially produced by I²R losses. Other losses may also be added to this, for example those owing to the skin effect or eddy-current losses and hysteresis losses. The outer conductor 2 is heated to a relatively small extent since it has a larger cross section and is subjected to the ambient air. However, this does not apply to the inner conductor 10. It is therefore advantageous for achieving high operating currents to provide a cooling device for the inner conductor 10, as shown in FIGS. 2a and 2b. The cooling device is preferably designed such that the heavy-duty circuit breaker is generally no warmer than 105 or at most 120° C.

The cooling device is formed by a heat pipe (in particular a thermosiphon) 3, as is described in FIG. 1. The description relating to FIG. 1 therefore substantially also applies to FIGS. 2a and 2b, and the same reference symbols denote functionally similar parts.

The heat pipe 3 illustrated in FIG. 2a has two metallic evaporators 20, which are substantially in the form of hollow cylinder segments and whose form is matched to the shape of the inner conductor 10. The internal volumes of the two evaporators are connected to one another by preferably metallic pipes belonging to the heat pipe 3. The pipes are furthermore connected to a condenser 50. The condenser 50 has a preferably metallic cooling rib arrangement, which is fastened on the outer conductor. In the condenser, the gaseous working medium can propagate in order to then condense after heat has been emitted (see FIG. 1). The cooling device therefore extends into an exterior of the electrical operating means.

The cooling device illustrated in FIG. 2b is similar to the cooling device from FIG. 2a, and the same reference symbols denote functionally similar parts. The evaporator illustrated in FIG. 2b, however, has two times two metallic evaporators 20, which are substantially in the form of hollow cylinder segments, with a contact face, whose form is matched to the shape of the surface of the inner conductor 10. These elements are connected to one another and to the condenser 50 by preferably metallic pipes.

Instead of the 2 or 4 elements illustrated in FIGS. 2a and 2b, the heat pipe 3 may also have 1, 3, 5, 6, 7, 8 or more elements, which absorb the heat from the inner conductor 10. More than one heat pipe can be fitted to the inner conductor 10 in order to increase the cooling power. For example, the inner conductor 10 may have a plurality of sections which are each provided with at least one heat pipe.

In many applications, the cooling power is limited in particular by the quality of the thermal contact between the heat source 10 and the contact wall 30 of the cooling device 3. It is therefore advantageous to ensure contact between these parts which is as thermally conductive as possible and is compatible with a tight coolant occlusion.

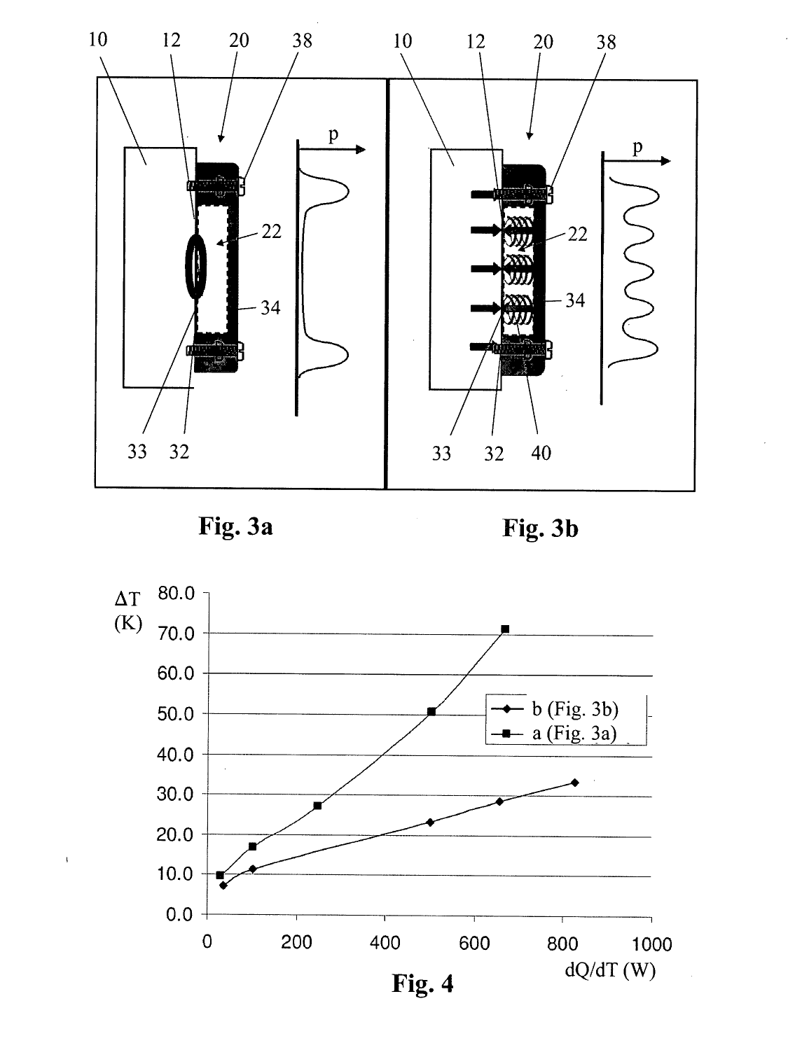

The difficulties when producing a contact which is as thermally conductive as possible are illustrated in FIG. 3a. This shows an evaporator 20, which is not in accordance with the invention, of a heat siphon. The heat siphon corresponds to the design shown in the preceding figures, and the same reference symbols denote functionally similar parts. The evaporator 20 is fastened to a heat source 10 using fastening screws 38, with the result that the contact face 32 of the evaporator rests on the surface 12 to be cooled of the heat source. However, a fixed pressure contact between a contact face 33 of the contact wall 32 and the surface 12 to be cooled is only ensured in the region of the fastening screws 38. Other regions of the contact face 33 are not pressed against the surface to be cooled.

In the pressure graph on the right-hand side in FIG. 3a, the contact pressure is illustrated as a function of the vertical position in the cross-sectional plane. The graph illustrates that a high contact pressure is only present in the region of the fastening screws, but not in the region lying between the fastening screws, which is highlighted on the left-hand side in FIG. 3a by an ellipse. The region lying between the fastening screws, however, is the region which is decisive for the transfer of heat, since the contact wall 32 is thin and consequently particularly thermally conductive in this region. Owing to the low contact pressure, the thermal contact is severely reduced in this region. In particular, the low contact pressure favors the formation of thermally insulating air cushions, for example if there are manufacturing tolerances or microscopic irregularities. Such air cushions can furthermore also arise in the event of operationally induced fluctuations, for example, in the pressure in the internal volume 22, since such fluctuations and similar fluctuations may result in an undesired movement of the contact wall 32 and therefore in a change in the areal contact.

In order to produce the desired areal contact, it is advantageous to apply thermally conductive paste between the surface 12 to be cooled and the contact face of the contact wall 32, but under certain circumstances this may have insufficient or inadequate long-term stability. The application of additional fastening screws in this region is generally associated with losses with respect to the sealing of the internal volume 22.

FIG. 3b illustrates an evaporator 20 according to the invention of a heat siphon. In addition to the features of FIG. 3a, this evaporator has contact-pressure springs 40. The contact-pressure springs 40 exert an areal contact pressure, i.e. a contact pressure which is distributed over the area, on the contact wall 32. As a result, the contact wall 32 is mechanically prestressed, with the result that it is pressed against the surface 12 to be cooled. Areal contact between the contact face 33 and the surface 12 to be cooled is therefore produced. The contact pressure is illustrated symbolically in FIG. 3b as pairs of arrows pointing towards one another. The contact pressure is also illustrated in the pressure graph on the right-hand side in FIG. 3b. The pressure graph shows that, in contrast to the evaporator shown in FIG. 3a, a contact pressure is also produced in the region of the contact wall which is between the fastening screws 38.

The contact-pressure springs 40 are fastened in the interior of the evaporator 20, i.e. in the volume 22 in which the coolant is located. They transfer a contact pressure or a contact-pressure force onto the contact wall 32, as is described above. They also transfer a corresponding counterpressure or a counterforce onto the rear wall 34, which is opposite the contact wall 32, of the evaporator 20.

The distribution of the contact-pressure springs 40 or other contact-pressure means can be varied. A distribution of the contact pressure over the contact face which is as uniform as possible is desirable irrespective of the embodiment shown. For this purpose, depending on the form of the contact face, a hexagonal or square distribution of the contact-pressure springs or the other contact-pressure means over the contact wall is particularly suitable.

Irrespective of the embodiment shown, the contact wall consists of a thermally conductive material, which contains, for example, a metal such as aluminum, copper or steel. It is as thin as possible in order to achieve good thermal conductivity and, depending on the material, is, for example, thinner than 20 mm, thinner than 10 mm or thinner than 5 mm or even thinner than 2 mm.

Irrespective of the embodiment shown, the contact face is coated with a material which is softer than the base material, for example with silver. In this way, small irregularities of the contact face or of the surface to be cooled can be compensated for.

As shown in FIGS. 3a and 3b, the fastening screws 40 also produce a contact pressure. However, this contact pressure is produced without the contact wall 32 being prestressed. The fastening screws 38 therefore in particular do not produce a force-fitting connection between the surface 12 to be cooled and the contact face 33 of the contact wall 32.

During operation of the electrical operating means, the coolant is heated. In this case, the gas pressure in the volume 22 generally increases, at least if the volume is sealed off in a gas-tight manner. This gas pressure can also produce a contact pressure between the surface 12 to be cooled and the contact face 33. The gas pressure has a sensitive dependence on the respective operating conditions and is therefore subject to severe fluctuations. In some embodiments, the gas pressure may fluctuate between a minimum pressure of 1 bar (normal pressure) and 1.5 bar, 2 bar or even 3 bar.

A contact-pressure means may also be provided by virtue of the fact that the coolant volume is subjected to an excess pressure (for example a gas pressure of 2 bar). In this case, there is no mechanical prestress. A mechanical prestress has the advantage that it is generally relatively independent of the respective temperatures in the coolant volume.

Irrespective of the embodiment shown, the pressure of the coolant and/or the pressure in the interior of the peripheral wall in the given operating conditions is typically not below a minimum pressure (in this case 1 bar). The contact pressure is then preferably greater, and optionally greater by more than 0.2 bar or by 0.5 bar, than the difference between the pressure of the surrounding environment, for example the ambient air, and the minimum pressure. In embodiments, the contact pressure of the contact-pressure means is more than 0.5 bar, typically even more than 1 bar or more than 2 bar.

Irrespective of the embodiment shown, the contact wall is mechanically prestressed. A contact pressure of the contact face against the surface to be cooled is therefore also produced when the pressure (gas pressure or similar, in particular non-mechanical pressure) in the interior of the peripheral wall is not greater than the pressure outside the peripheral wall. Mechanical prestress is in this case understood to mean a prestress which is achieved by technical mechanical means, i.e. a prestress which is based, for example, on elastic properties of the contact-pressure means or on effects which are equivalent to these.

FIG. 4 shows a measurement graph, which makes it possible to compare the cooling effect of the cooling devices from FIG. 3a, i.e. without contact-pressure springs (curve “a”), and from FIG. 3b, i.e. with contact-pressure springs (curve “b”). On the horizontal axis of the measurement graph, the thermal power of the heat source 10 shown in FIGS. 3a and 3b is illustrated. In this case, an electrical heating block has been selected as the heat source. On the vertical axis, the temperature difference between a point in the interior of the heat source and a point on the surface 12 to be cooled is plotted. This variable is a direct measure of the thermal contact conductivity of the respective cooling device. As a good approximation, the temperature difference in the measured temperature range is proportional to the thermal contact conductivity between the surface 12 to be cooled and the contact face 33. FIG. 4 shows that, owing to the contact-pressure springs, the thermal contact conductivity is improved by approximately a factor of 2.

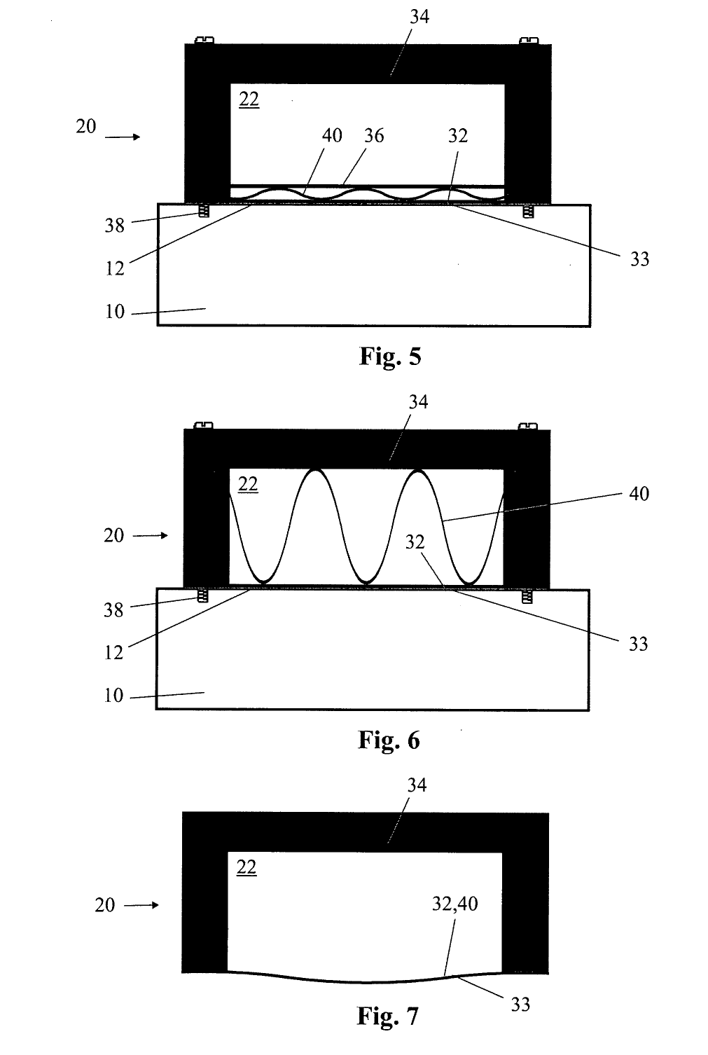

FIGS. 5 to 7 show schematic views of further cooling devices according to the invention. In each case only the region of the evaporator 22 is illustrated, as is also the case in FIGS. 3a and 3b. The remainder of the cooling device could be designed as in FIGS. 1 and 2. The same reference symbols denote parts which are functionally similar to the cooling devices in the preceding figures.

In the embodiment shown in FIG. 5, the contact-pressure spring 40 is in the form of a leaf spring. The leaf spring may comprise a plurality of narrow elements or a mesh-like material, with the result that coolant circulation from and to the contact wall 32 is possible. The counterforce to the contact-pressure force is produced in FIG. 5 by a web 36, which is fastened laterally to the peripheral wall of the evaporator 20. The contact-pressure spring 40 is also in the form of a leaf spring in the embodiment shown in FIG. 6.

In the embodiment shown in FIG. 7, the contact wall 32 is curved outwards and is therefore mechanically preformed, in order to produce a prestress in the direction of the face to be cooled. The curvature of the contact wall is illustrated to an exaggerated extent in FIG. 7. Owing to the preforming of the contact wall 32, a contact pressure against the surface to be cooled and a force-fitting connection are made possible when the evaporator is fastened to the heat source. Thus, the cooling device shown in FIG. 7 has a contact-pressure means which is realized by the preforming of the contact wall 32.

The embodiments shown can be varied further without leaving the scope of protection defined in the claims. For example, any desired cooling by means of a coolant can be used, irrespective of whether it is passive or active cooling. The invention is therefore also suitable for water cooling or another type of cooling by means of a liquid or cooling gas flow, irrespective of whether a pump or fan is used.

The invention has been described with reference to cooling of a generator circuit breaker. More generally, it relates to any desired electrical operating means, for example also switches, transformers or surge arresters. For example, the electrical operating means may be a circuit breaker, in particular a heavy-duty circuit breaker for example of a high-voltage installation. In addition, the cooling can be used not only for electrical operating means such as the generator circuit breaker shown, but also for electrical or other devices of any type.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### List of Reference Symbols

### 1 Electrical operating means

### 2 Enclosure of the electrical operating means

### 3 Cooling device

### 10 Heat source

### 12 Surface to be cooled

### 20 Evaporator

### 22 Internal volume

### 26 Coolant

### 27 Condensed coolant

### 30 Peripheral wall

### 32 Contact wall

### 33 Contact face

### 34 Opposite wall

### 36 Web

### 38 Fastening means

### 40 Prestressing element

50 Heat sink/apparatus for emitting heat to the surrounding environment

What is claimed is:

1. A cooling device for an electrical operating means, which has a surface to be cooled; the cooling device comprises
a coolant,
a peripheral wall, whose interior defines a volume for the coolant,
a fastening for fastening the cooling device to the electrical operating means, and
a contact-pressure means, the peripheral wall having a thermally conductive contact wall with a contact face, which is designed for areal contact with the surface to be cooled, and the contact-pressure means mechanically prestressing the contact wall in order to produce an areal contact pressure of the contact face against the surface to be cooled when the cooling device is fastened to the electrical operating means.

2. The cooling device as claimed in claim 1, the contact wall having a flexible (resilient) region with a variable deflection, and the contact-pressure means acting on the flexible region.

3. The cooling device as claimed in claim 1, the contact-pressure means being a spring.

4. The cooling device as claimed in claim 3, the contact-pressure means being arranged in the volume for the coolant or directly adjoining the volume for the coolant.

5. The cooling device as claimed in claim 1, the contact wall having a base material and a coating, and the coating being softer than the base material.

6. The cooling device as claimed in claim 1, the contact-pressure means being arranged in order to transfer a counterpressure to the contact pressure onto the peripheral wall.

7. The cooling device as claimed in claim 1, the electrical operating means being a circuit breaker.

8. The cooling device as claimed in claim 1, the cooling device being a heat pipe and containing an evaporator for evaporating the coolant, and the peripheral wall of the evaporator having the contact wall, furthermore comprising
a condenser for condensing the coolant, which condenser is connected to the evaporator and has an apparatus for emitting heat to the surrounding environment.

9. The cooling device as claimed in claim 1, the interior of the peripheral wall being sealed off in a gas-tight manner from the surrounding environment.

10. The cooling device as claimed in claim 1 which is a passive cooling device.

11. The cooling device as claimed in claim 1, a pressure exerted by the contact-pressure means onto the contact wall having a lower temperature dependence than the gas pressure of a gas located in the interior of the peripheral wall.

12. An electrical operating means having a cooling device fastened to it as claimed in claim 1.

13. A method for producing a cooling device for an electrical operating means, which has a surface to be cooled, comprising the following steps:
a peripheral wall with a thermally conductive contact wall is formed,
a fastening for fastening the cooling device to the electrical operating means is formed,
a contact face of the contact wall is designed such that it permits areal contact of the contact face with the surface to be cooled,
the contact wall is prestressed by a contact-pressure means in such a way that a contact pressure of the contact face against the surface to be cooled can be produced when the cooling device is fastened to the electrical operating means, and
a coolant is made available in a volume defined by the interior of the peripheral wall.

14. The cooling device as claimed in claim 7, the cooling device being a heat pipe and containing an evaporator for evaporating the coolant, and the peripheral wall of the evaporator having the contact wall, furthermore comprising
a condenser for condensing the coolant, which condenser is connected to the evaporator and has an apparatus for emitting heat to the surrounding environment.

15. The cooling device as claimed in claim 8, the interior of the peripheral wall being sealed off in a gas-tight manner from the surrounding environment.

16. The cooling device as claimed in claim 9 which is a passive cooling device.

17. The cooling device as claimed in claim 10, a pressure exerted by the contact-pressure means onto the contact wall having a lower temperature dependence than the gas pressure of a gas located in the interior of the peripheral wall.

18. An electrical operating means having a cooling device fastened to it as claimed in claim 11.

19. A method for producing a cooling device which has a surface to be cooled, comprising the following steps:
a peripheral wall with a thermally conductive contact wall is formed,
a fastening for fastening the cooling device is formed,
a contact face of the contact wall is configured to permit contact of the contact face with the surface to be cooled,
the contact wall is prestressed in such a way that a contact pressure of the contact face against the surface to be cooled can be produced when the cooling device is fastened using the fastening, and
a coolant of a volume defined by the interior of the peripheral wall is provided.
